(19) United States
(12) Patent Application Publication
(10) Pub. No.: US 2009/0239110 A1
(43) Pub. Date: Sep. 24, 2009

(54) REFORMER FOR A FUEL CELL SYSTEM

(75) Inventors: Matthias Boltze, Neuendorf (DE); Michael Rozumek, Neubrandenburg (DE); Stefan Käding, Zerrenthin (DE); Andreas Lindermeir, Neubrandenburg (DE); Norbert Günther, Ribnitz (DE); Jeremy Lawrence, Dresden (DE); Andreas Reinert, Dresden (DE); Marco Mühlner, Raduhn (DE); Stefan Kah, Neubrandenburg (DE)

Correspondence Address: DICKINSON WRIGHT PLLC, 1875 Eye Street, NW, Suite 1200, WASHINGTON, DC, 20006, US

(73) Assignee: ENERDAY GMBH, Stockdorf (DE)

(21) Appl. No.: 12/302,455

(22) PCT Filed: Jun. 12, 2007
(86) PCT No.: PCT/DE2007/001035

§ 371 Date: Nov. 25, 2008

(30) Foreign Application Priority Data
Jun. 29, 2006 (DE) 10 2006 029 917.5

(51) Int. Cl. H01M 8/06

(52) U.S. Cl. 429/19

(57) ABSTRACT

The invention relates to a reformer for a fuel cell system for generating a reformate comprising a plurality of function units for treating the fuel, at least one function unit being adapted to a first type of fuel. In this arrangement the invention is characterized to advantage in that the function unit adapted to the first type of fuel can be releasably coupled to the reformer as a module by means of an interface which is also designed to couple a replacement function unit instead of the function unit adapted to the first type of fuel, the replacement function unit being adapted to a second type of fuel different from the first type of fuel. The invention relates furthermore to a function unit for such a reformer, to a fuel cell system having such a reformer and to a motor vehicle having such a fuel cell system.

The invention relates to a reformer for a fuel cell system for generating a reformate comprising a plurality of function units for treating the fuel, at least one function unit being adapted to a first type of fuel.

In addition, the invention relates to a function unit for such a reformer, to a fuel cell system having such a reformer and to a motor vehicle having such a fuel cell system.

Fuel cell systems serve to convert chemical energy into electrical energy by ways and means as known generally. Fuel cell systems must be capable of handling fuels in normal use. Since hydrogen and oxygen are reacted in a fuel cell the fuel used must be conditioned so that the gas supplied to the anode of the fuel cell stack is rich in hydrogen. At the cathode end air oxygen is supplied to the fuel cell stack in most cases. For this purpose, fuel and an oxidant, preferably air, is fed to a reformer. The fuel is then reacted with the oxygen in the reformer, preferably by the method of partial oxidation. A conventionally configured reformer is described, for example, in German patent DE 101 20 375 A1.

The reformate generated as such is then supplied to the fuel cell or fuel cell stack, electrical energy being liberated by controlled reaction of the hydrogen as a component of the reformate, and oxygen.

Independent of the type of fuel used, the aim is always to achieve as high a percentage of hydrogen as possible in the reformate which is then fed to the fuel cell stack. For this purpose and depending on the fuel used, the reformer needs to be adapted to this particular fuel. This requires producers of such fuel cell systems to offer a wide choice of fuel cell systems, each specially adapted to the particular fuel concerned, thus involving high development and production costs.

It is thus the object of the present invention to now make it possible to provide a reformer which can be adapted to various kinds of fuel relatively cost-effectively.

This object is achieved by the features of the independent claims.

Advantageous aspects and further embodiments of the invention read from the dependent claims.

The reformer in accordance with the invention is based on generic prior art in that the function unit adapted to the first type of fuel can be releasably coupled to the reformer as a releasable module by means of an interface which is also designed to couple a replacement function unit instead of the function unit adapted to the first type of fuel, the replacement function unit being adapted to a second type of fuel different from the first type of fuel. Such a configuration now makes it possible to repeatedly use salient function units of the reformer in operation with different types of fuel in thus enabling the reformer to be adapted to the various requirements of the differing type of fuel highly cost-effective and by simple ways and means. This now makes it possible to optimally adapt a complete fuel cell system to another type of fuel simply by replacing a function unit of the reformer.

The same advantages are achievable in that the function unit adapted to the first type of fuel and the replacement function unit is a gas mixer.

More particularly it is thereby provided for that the gas mixer is an evaporator.

In addition, the aforementioned advantages are achievable in that the function unit adapted to the first type of fuel and the replacement function unit is a reaction unit.

More particularly it is thereby provided for that the reaction unit is an reformer burner.

In addition, the reformer in accordance with the invention can be sophisticated by engineering the interface as a quick-release connector. By comprising a quick-release connector the modular structure of the reformer and replacing a function unit can be quickly implemented user-friendly without involving a complicated disassembly of the reformer.

More particularly it is thereby provided for that the interface is a bayonet connector.

Provided furthermore in accordance with the invention is a function unit for a reformer having an interface designed for coupling such a reformer. With such a function unit the advantages as described above are correspondingly achievable.

In addition, the invention provides a fuel cell system having such a reformer and a motor vehicle having such a fuel cell system furnishing the advantages as described above correspondingly.

By way of example a preferred embodiment of the invention will now be detailed with reference to the drawing in which:

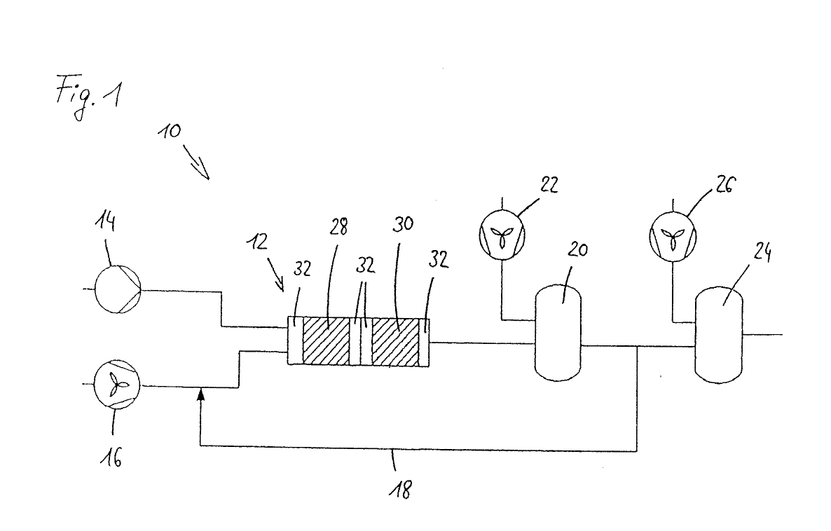

FIG. 1 is a diagrammatic representation of the fuel cell system in accordance with the invention.

Referring now to FIG. 1 there is illustrated a diagrammatic representation of the fuel cell system in accordance with the invention. The fuel cell system 10 comprises a reformer 12 receiving a supply of fuel from a fuel pump 14. The type of fuel involved includes diesel, gasoline, biogas, natural gas and further types of fuel known from prior art. The reformer 12 also receives a supply of oxidant which in this case is composed of air delivered by a blower 16 and the anode exhaust gas 18 entrained therein. The anode exhaust gas 18 is generated by a fuel cell 20 assigned a fuel cell blower 22 and receiving a supply of reformate generated by the reformer 12. The reformate involved is a hydrogen-rich gas which with the aid of cathode air delivered by the fuel cell blower 22 is converted in the fuel cell 20 into electricity and heat. In this case the non-returned portion of the anode exhaust gas 18 is supplied to an afterburner 24 assigned an afterburner blower 26. In the afterburner 24 the depleted reformate is converted by the air delivered by the afterburner blower 26 into a combustion exhaust gas containing next to no noxious emissions.

The reformer 12 comprises a gas mixer 28 and a reaction unit 30. Formed in the gas mixer 28 from the fuel and an oxidant, preferably air, is a gas mixture, preferably involving evaporation of the fuel. This gaseous mixture reacts in the reaction unit 30 to reformate preferably by partial oxidation. In this arrangement the gas mixer 28 is preferably an evaporator and the reaction unit 30 is preferably a reformer burner. The gas mixer 28 as well as reaction unit 30 are coupled, by means of interfaces 32, preferably configured as quick-release connectors such as for example a bayonet, screw or plug-in connector, to the reformer and the remaining function units of the reformer respectively. A quick-release connector in this sense is understood to be a mechanically releasable connector for positive or non-positive contact with which coupling can be performed preferably without requiring a tool. The reformer is accordingly sub-divided into releasable modules which can be quickly replaced user-friendly when required. The reformer and thus the complete fuel cell system is in this configuration adapted to a certain type of fuel.

Should a change be needed to another type of fuel, the function units of the reformer adapted to a certain type of fuel can be replaced by other function units preferably having the same function but adapted to a different type of fuel. For this purpose the interfaces of the function units adapted to various types of fuel and interchangeable preferably feature identical interfaces so that all interchangeable function units are, as to dimensions and connections, optimally compatible with the reformer and the other function units.

Various possibilities exist as regards intercoupling the function units or with the reformer. For instance, the reformer can be configured from a plurality of function units coupled in series so that an interface of a stand-alone function unit forms the input of the reformer. The other interface of this stand-alone function unit is coupled to the following function unit which, in turn, may be coupled to a function unit until the interface of the last function unit forms an output of the reformer. Another possibility would be to provide a reformer housing comprising interfaces at the housing end to which the function units are coupled by means of their interfaces. In this situation, the interfaces at the housing end would need to be connected within the housing for interconnecting the function units in operation.

It is understood that the features of the invention as disclosed in the above description, in the drawings and as claimed may be essential to achieving the invention both by themselves or in any combination.

### LIST OF REFERENCE NUMERALS

10 fuel cell system
12 reformer
14 fuel pump
16 blower
18 anode exhaust gas
20 fuel cell
22 fuel cell blower
24 afterburner
26 afterburner blower
28 gas mixer
30 reaction unit
32 interfaces

1. A reformer for a fuel cell system for generating a reformate, comprising a plurality of function units for treating the fuel, at least one function unit being adapted to a first type of fuel, characterized in that the function unit adapted to the first type of fuel can be releasably coupled to the reformer as a module by means of an interface which is also designed to couple to the reformer a replacement function unit instead of the function unit adapted to the first type of fuel, the replacement function unit being adapted to a second type of fuel different from the first type of fuel.

2. The reformer of claim 1, characterized in that the function unit adapted to the first type of fuel and the replacement function unit is a gas mixer.

3. The reformer of claim 2, characterized in that the gas mixer is an evaporator.

4. The reformer of claim 1, characterized in that the function unit adapted to the first type of fuel and the replacement function unit is a reaction unit.

5. The reformer of claim 4, characterized in that the reaction unit is a reformer burner.

6. The reformer of claim 1, characterized in that the interface is a quick-release connector.

7. The reformer of claim 6, characterized in that the interface is a bayonet connector.

8. A function unit for a reformer comprising an interface designed for coupling the reformer of claim 1.

9. A fuel cell system comprising a reformer of claim 1.

10. A motor vehicle comprising a fuel cell system of claim 9.
